(19) United States
(12) Patent Application Publication
(10) Pub. No.: US 2021/0346929 A1
(43) Pub. Date: Nov. 11, 2021

(54) ALIGNING DEVICE FOR A WIRE PROCESSING MACHINE AND METHOD FOR OPERATING AN ALIGNING SYSTEM

(71) Applicant: SCHLEUNIGER AG, Thun (CH)

(72) Inventor: Uwe KEIL, Hückeswagen (DE)

(21) Appl. No.: 17/286,899

(22) PCT Filed: Oct. 31, 2018
(86) PCT No.: PCT/IB2018/058545

§ 371 Date: Apr. 20, 2021

(51) Int. Cl. B21C 51/00; B21F 1/02; G01B 11/10

(52) U.S. Cl. CPC B21C 51/00; G01B 11/10; B21F 1/02

(57) ABSTRACT

An aligning device (15) for straightening a wire (11) which comprises an aligning system (20) having a first row of rollers (21) and a second row of rollers (31) which can be moved relative to one another. The aligning device (15) comprises a measuring unit (40) for determining a wire diameter and/or a tensile force measuring mechanism (70). A method for adjusting the aligning system (20) and a method for setting the aligning system (20), as well as a wire processing machine having at least one aligning device (15) are also disclosed.

The invention relates to a straightening device for straightening a wire, a method for operating a straightening unit and a wire processing machine.

Wire processing machines include multiple stations at which a wire or wire is processed in steps to yield an end product. The wires are typically supplied to the wire processing machine on drums or as bundles. In a first step, these are unwound from the drum or bundle. The unwound wires are bent and twisted to a greater or lesser degree, which makes it more difficult to complete subsequent processing steps with the wire processing machine. In order to straighten the wires as far as possible, they are typically drawn through a straightening device. A wire processing machine should also be able to process a very wide variety of wires.

Various apparatuses for straightening a wire are known from the related art. For the purposes of the present, a wire is understood to be a quasi-endless wire and also a wire section of a quasi-endless wire, which may have different structures. The wire may be a single conductor, it may consist of multiple twisted strands, or it may be a solid conductor, each of which may be made from copper or another electrically conductive alloy or a light-guiding material. The wire may additionally have a wire insulation.

It is required of these apparatuses that they straighten the wire sufficiently. A sufficiently straightened wire is recognisable by the fact that after straightening it can be inserted into and passes through a predefined space, for example a cylindrical lumen, without exceeding the limits of said predefined space. In this way, an individual predefined space can be defined for each wire that is to be straightened, and this space represents an essential quality criterion for the respective straightened wire or wire type, as well as for a wire processing machine.

Document EP 3 184 191 A1 discloses a straightening unit with an upper and a lower row of rollers. These two rows of rollers are movable relative to each other, wherein the distance between the rows of rollers can be monitored with sensor equipment by means of a measuring unit. The measuring unit may be connected to a controller. A previously known or previously measured outer diameter of the wire, for example, may be taken as the target value for the distance between the rollers. It is suggested to connect the measuring unit to a memory unit and record the actual values and/or the deviation between the actual values and the target value. It is further suggested to monitor the adjustment angle between the two rows of rollers by means of corresponding sensors. All target values may be stored in a controller as a mathematical function or a table. Document EP 2 399 856 A1 also describes a species-related straightening unit.

The disadvantage of the known apparatuses is that straightening the wires with these apparatuses is a complex task, and the straightening unit in the apparatus is not adjusted with sufficient accuracy. For example, the distance between the rows of rollers may vary in sections along a wire that is to be straightened if the wire to be straightened is not arranged exactly between the rows of rollers. This results in insufficient straightening of the wire, and after this in additional effort and expense during subsequent wire processing.

The problem addressed by the present invention is that of remedying one or more disadvantages of the related art. In particular, a straightening device is to be created which improves the straightening of wires, particularly of electrical or optical wires. Further, methods are to be devised for setting and adjusting a straightening unit in a straightening device which improves the straightening of wires, in particular of electrical or optical wires. Besides this, wire processing machines are to be produced with which an improved straightening of a wire is made possible.

This problem is solved with the apparatuses and methods defined in the independent claims. Advantageous further developments are presented in the figures, the description and in particular in the dependent claims.

A straightening device according to the invention for straightening a wire comprises a straightening unit with a first row of rollers and a second row or rollers which are movable relative to each other. The straightening device comprises a measuring unit for determining a wire diameter.

The measured wire diameter may be used to synchronise the operation of the first row of rollers relative to the second row of rollers with the respective wire provided in the straightening unit in such a way that prevents excessive load from being placed on the wire with the straightening unit in the set state. With the measuring unit, at least one specific value of the wire may be determined directly curing operation of the straightening device. At the same time, this improves the straightening of the wire in the straightening device in subsequent processing.

A row of rollers includes at least two rollers. The rollers are advantageously arranged on a shared carrier. The second row of rollers is typically that row of rollers on which the wire rests on when inserted in the straightening unit and which is connected directly and immovably to the straightening unit.

The measuring unit is preferably arranged on the straightening unit. In this way, the determination of the wire diameter takes place directly on the straightening unit, and consequently a specific value is defined for the wire provided in the straightening unit. This in turn enables a quasi-endless wire for example to be at least partly characterized directly in the straightening unit and multiple times at different sections of the wire during the straightening process. An additional measuring unit for determining a wire diameter outside of the straightening devices is unnecessary.

The measuring unit for determining the wire diameter is preferably embodied as an ultrasonic sensor. This way, the wire diameter can be determined contactlessly.

Alternatively, the measuring unit for determining the wire diameter is embodied as a laser sensor. Laser sensors also determine the wire diameter of the wires contactlessly, and a laser sensor can easily be arranged in the area surrounding the wire. Laser sensors typically exhibit a high degree of long-term stability. They are easily installed in a straightening device and are simple to calibrate.

In particular, the laser sensor is embodied as a laser curtain. A laser curtain is typically made up of multiple laser beams arranged side by side. The multiple laser beams can easily be arranged on various sections in the measurement area of the wire, thus enabling an accurate determination of the wire diameter.

More preferably, the measuring unit is equipped with at least one measuring roller and one pinch roller disposed opposite the at least one measuring roller, these rollers being arranged in such manner that the wire can pass through between the at least one measuring roller and the pinch roller. A distance between the at least one measuring roller and the pinch roller is adjustable with a measuring roller drive for moving the at least one measuring roller. In this context, the wire diameter may be determined on the basis of the distance between the at least one measuring roller and the pinch roller. The measuring roller drive also makes it possible to increase the distance between the at least one measuring roller and the pinch roller, so that a wire can easily be placed between the measuring roller and the pinch roller. The distance can be decreased using the measuring roller drive, so that the measuring roller circumference of the at least one measuring roller comes into contact with the provided wire and may or may not press it against the pinch roller. The at least one measuring roller may be mounted so as to be rotatable on the carrier, so that the wire is treated gently as it passes between the at least one measuring roller and the pinch roller. Alternatively or additionally, the pinch roller may be mounted rotatably on the carrier of the second row of rollers, so that the surface of the wire is subjected to minimal load as it passes through.

In particular, the measuring roller drive is a pneumatic drive, with which the at least one measuring roller is easily able to apply a predefined contact pressure to the wire that is to be straightened.

The measuring unit for determining the wire diameter preferably includes at least one sensor from the following group: travel sensor, position sensor, distance sensor. With these sensors, it is possible to determine a distance between the at least one measuring roller and the pinch roller. It is a simple matter to determine the wire diameter using the measurement data from the sensor.

The pinch roller is more preferably arranged on the second row of rollers. Then, the pinch roller can be connected fixedly to the straightening unit at its axis, so that the wire to be straightened lies firmly on the pinch roller.

In particular, the second row of rollers includes multiple rollers, wherein the pinch roller of the measuring unit is embodied as one of the multiple rollers. In this way, the pinch roller is mounted directly on the second row of rollers, and is therefore held firmly in place on the straightening unit.

The straightening device preferably has a control unit. The control unit may be connected with at least one drive for the straightening device as described here, so that this at least one drive may be controlled automatically. The components and/or parts of the straightening device which are connected to the control unit are connected to the control unit in order to exchange measurement data, sensor data and/or control data or control commands. This exchange may take place with the aid of a cable connection between the control unit and component or element and/or wirelessly via WLAN, LAN, Bluetooth® or other wireless data exchange options.

The control unit preferably includes a computing unit and a memory unit. The computing unit and the memory unit are connected to each other. The computing unit is designed to generate at least one control command for the at least one drive of the straightening device and optionally to transmit it to the memory unit. The memory unit stores the at least one Save command. The computing unit receives measurement data from the measuring unit and calculates a target value either directly or indirectly therefrom. Target values may also be stored in the memory unit to set the first row of rollers relative to the second row of rollers, and are retrievable by the computing unit. Thus, the computing unit is subsequently able to generate a control command based on the target value for the at least one drive in the straightening unit.

In particular, the control unit is connected to a database. Consequently, it is possible for typically externally generated control commands, externally saved target values, or externally saves wire-specific parameters to be retrieved from the database by the control unit. These stored target values, control commands and/or wire-specific parameters can be used in the computing unit to generate a control command for the at least one drive in the straightening device. The database may also be capable of storing the abovementioned target values. These stored target values may or may not be transmitted to the computing unit of the control unit and processed further there.

More preferably, the measuring unit is connected to the control unit for the purpose of sending measurement data. The measurement data calculated by the measuring unit may thus be transmitted to the control unit and to the computing unit and processed further there.

In particular, the measuring unit is connected to the control unit for the purpose of sending the wire diameter or a corresponding value, so that the control unit receives the value for the wire diameter directly, or is able to determine a wire diameter in the computing unit using the corresponding value.

The control unit is preferably connected to the measuring roller drive. The control unit controls at least the measuring roller drive, with which the at least one measuring roller is moved towards the contact pressure roller in controlled manner. As the at least one measuring roller moves closer to the contact pressure roller, the at least one measuring roller comes into contact with the wire arranged between the at least one measuring roller and the contact pressure roller. The distance between the at least one measuring roller and the contact pressure roller is sent to the control unit by the measuring unit.

The straightening unit preferably has a setting drive, with which the first row of rollers can be set relative to the second row of rollers.

In this way, the first row of rollers may be moved relative to the second row of rollers and a certain distance may be set between the first row of rollers and the second row of rollers. The distance is calculated on the basis of the wire diameter of a corresponding wire introduced between the first row of rollers and the second row of rollers. After setting, the wire between the first row of rollers and the second row of rollers is recorded and incorporated.

Preferably, the distance in a previous measurement of the wire diameter of the wire is taken into account by the measurement. For this purpose, the control unit may be connected to the setting drive, and corresponding control commands may be sent to the setting drive.

Provision may be made to continuously compare a target value for the distance with an actual value for the distance, which is determined on the basis of the wire diameter. For this purpose, a measuring apparatus may be provided on the setting drive.

In particular, the setting drive is designed as a pneumatic drive, with the result that the straightening unit is set in a controlled manner and a suitable holding pressure is applied to the wire that is to be straightened.

The straightening unit preferably has a swivel drive for adjusting an angle between a roller axis of the first row of rollers and a roller axis of the second row of rollers. In such a situation, at least sections of the wire to be straightened is clamped between the first row of rollers and the second row of rollers because of the angle set, so that a portion of the wire to be straightened is held fast in the straightening unit. Thus, the straightening of the wire outside the straightening unit is improved. Typically, the swivel drive is connected to the control unit, so that the control unit can transmit control commands to the swivel drive. This enables the clamping of the wire to be controlled continuously and at the same time treating the wire gently.

A row of rollers includes multiple rollers which are arranged inside the straightening device substantially along a transport direction of the wire. The rollers of a row of rollers may be arranged at intervals and offset from each other along the transport direction of the wire. The roller axis of the first row of rollers described here is a mathematical axis which extends along the transport direction of the wire from a first roller of the first row of rollers to another roller of the first row of rollers. The roller axis of the second row of rollers described here is a mathematical axis which extends along the transport direction of the wire from a first roller of the second row of rollers to another roller of the second row of rollers. With the straightening unit in the open state, the roller axis of the first row of rollers is typically aligned substantially parallel to the roller axis of the second row of rollers along the transport direction of the wire.

The straightening device preferably has a tensile force measuring means to determine a wire tensile force acting on the wire. This serves to further improve the straightening of the wire. At the same time, a further specific value of the wire in the straightening device can be determined, thereby further improving the setting of the first row of rollers relative to the second row of rollers in the straightening unit as described here or in the following text, so that the wire is overstretched during straightening, for example.

The first row of rollers preferably includes multiple rollers, the rollers of the first row of rollers being offset with respect to the rollers of the second row of rollers. This means that the wire can easily be held firmly between the rollers of the first row of rollers and the rollers of the second row of rollers, since in the set state the rollers of the first row of rollers are at least partially arranged between the rollers of the second row of rollers. This enables the wire in the straightening unit to be bent selectively and/or smoothed selectively, whereby undesirable tensions in the wire can be eliminated. During smoothing, the wire is deformed selectively in various spatial directions to relieve tensions in the wire.

In particular, the rollers of the first row of rollers and the rollers of the second row of rollers are each arranged on a carrier. One of the carriers has protrusions and one of the carriers has recesses, the protrusions being designed to engage in the recesses. In this way, a compact straightening unit can be created. In the state in which the two carriers are separated from each other, this ensures that the wire cannot become trapped between the two carriers when the first row of rollers is set relative to the second row of rollers, but is instead unavoidably arranged on the rollers of the first row of rollers and the rollers of the second row of rollers.

A further aspect of the invention relates to a method for operating a straightening unit, in particular a straightening unit in a straightening device as described herein, wherein the method comprises the following steps:
providing a wire between a first row of rollers and a second row of rollers in a straightening unit;
determining the wire diameter of the wire using a measuring unit;
calculating a target value for setting the first row of rollers relative to the second row of rollers based on the determined wire diameter;
setting the first row of rollers relative to the second row of rollers in accordance with the target value.

This enables setting of the first row of rollers relative to the second row of rollers based on the wire provided in the straightening unit, whereby the straightening of the wire is improved.

The steps of
determining the wire diameter of the wire using a measuring unit;
calculating a target value for setting the first row of rollers relative to the second row of rollers based on the determined wire diameter; and
setting the first row of rollers relative to the second row of rollers in accordance with the target value

are preferably repeated, so that the setting in the straightening unit is checked multiple times.

In particular, the steps described above are carried out continuously, so the straightening unit can be adjusted continuously. Accordingly, the wire diameter is determined continuously in the straightening unit, thereby ensuring a consistent quality of the wire straightening function.

More preferably, a wire-specific parameter is taken into account for calculating the target value in the straightening unit. Then makes it possible for a wire-specific parameter, typically the structure of the wire itself—for example the number of wire strands—and/or information about the wire isolation—for example the wire insulation material—, to be considered for calculating the target value for setting the first row of rollers relative to the second row of rollers.

After the first row of rollers has been set relative to the second row of rollers, the first row of rollers is preferably opened relative to the second row of rollers in order to reduce stress on the wire. This serves to prevent long-term plastic deformation of wire sections of the wire when the straightening unit is in the set state.

The first row of rollers is advantageously opened relative to the second row of rollers to relax the wire when the transport movement of the wire through the straightening unit is interrupted. It was found that even short interruption times cause plastic deformations in the wire. Consequently, these plastic deformations make it almost impossible to continue processing the wires.

A further aspect of the invention relates to a straightening device for straightening a wire, comprising a straightening unit with a first row of rollers and a second row of rollers which are movable relative to each other. The straightening device includes a tensile force measuring means for determining a wire tensile force acting on the wire. The straightening unit is constructed as described earlier. With the tensile force measuring means, the wire tensile force may be determined for each wire to be straightened directly in the straightening device, which in turn serves to prevent the wire from being overstretched subsequently during straightening. At the same time, this has the effect of improving straightening of the wire in the straightening device, so that a sufficiently straightened wire can be produced with this straightening device.

The tensile force measuring means preferably includes a group of rollers with a support and a contact pressure roller. The wire to be straightened is arranged between the support and the contact pressure roller of the group of rollers, wherein the contact pressure roller may be arranged so as to be positionally fixed. The support is designed to hold the wire steady in the tensile force measuring means.

In particular the support is constructed in two parts. The first part of the support may be located at a distance form he second part of the support, so that at least a section of the contact pressure roller can be arranged between the two parts of the support.

The support preferably includes two support rollers. This makes it possible for the wire that is to be straightened to pass through the group of rollers easily without damaging wire to be straightened.

In particular, the support has a U-shaped construction, which prevents the wire from slipping while the tensile force is being measured.

In particular, the support and its group of rollers are arranged in such manner that a wire passing between the support and the contact pressure roller is deflected by the positionally fixed contact pressure roller. In this way, the wire to be straightened is pretensioned as early as in the group of rollers, so the tensile force measurement can be started immediately.

More preferably, the contact pressure roller is connected to a sensor device for measuring a force acting on the contact pressure roller. The force acting on the contact pressure roller is calculated by the sensor device so that the wire tensile force can be determined on the basis of this measured force.

The sensor device preferably comprises a force transducer. The force transducer may be constructed as a bending bar or the like, and may be connected to the contact pressure roller. A force transducer enables the wire tensile force to be determined extremely accurately.

The sensor device is preferably arranged on the contact pressure roller. This enables the force acting on the contact pressure roller to be measured easily, directly at the contact pressure roller.

In particular, the sensor device comprises at least one strain gauge, which is arranged on the force transducer or on the contact pressure roller bearing and calculates the radial force acting on the contact pressure roller. The at least one strain gauge can be operated using a Wheatstone bridge or the like, thereby making an especially accurate determination of the radial force acting on the contact pressure roller.

In particular, the force transducer includes multiple strain gauges, thereby improving the measuring sensitivity of the sensor device.

Alternatively or additionally, the support has at least one strain gauge, which may be connected to the aforementioned Wheatstone bridge. This enables the measuring sensitivity of the tensile force measuring means to be improved further.

Preferably, at least the contact pressure roller is movable relative to the support. This enables conclusions to be drawn regarding the wire tensile force present in each case based on the movement of the contact pressure roller relative to the support.

In particular, the sensor device is a travel sensor system which is designed to determine the distance between the support and the contact pressure roller. The distance between the support and the contact pressure roller can subsequently be used determine the wire tensile force easily and reproducibly.

Alternatively, the travel sensor system determines a deviation from a known distance between the support and the contact pressure roller. For this purpose, the distance between the support and the contact pressure roller may be adjusted in advance depending on the wire diameter of the wire, and the deviation from this distance is subsequently calculated when the tensile force is measured.

In particular, the contact pressure roller is arranged to be able to swivel about the support. The distance or the deviation in distance from the support to the contact pressure roller may be determined using the deflection of the swivelling movement made by the contact pressure roller.

The contact pressure roller is preferably arranged so as to be movable linearly with respect to the support. In this way, an easily performed movement of the contact pressure roller is used in the tensile force measuring means to allow an accurate determination of the distance or distance deviation. For this purpose, the contact pressure roller may be connected to a contact pressure roller drive. The contact pressure roller drive may be driven for example by pneumatic, electrical or mechanical energy so that the distance between the support and the contact pressure roller can be adjusted reproducibly.

The sensor device is advantageously arranged between the contact pressure roller and the contact pressure roller drive and connected to both, thereby further improving the measuring sensitivity of the sensor device.

More preferably, the straightening unit is equipped with a swivel drive for adjusting an angle between a roller axis of the first row of rollers and a roller axis of the second row of rollers. The wire arranged between the first row of rollers and the second row of rollers can be bent and/or smoothed in defined manner as a function of the angle set between the roller axis of the first row of rollers and the roller axis of the second row of rollers so that the wire tensile force can be determined reproducibly. The roller axis of the first row or rollers and the roller axis or the second row of rollers extend substantially along the line of alignment of the rollers in each row of rollers.

The straightening unit preferably includes a setting drive, in particular a setting drive as described herein, with which the first row of rollers is adjustable relative to the second row of rollers. The setting of the straightening unit with the aid of the setting drive enables a defined adjustment of the straightening unit.

The straightening device preferably includes a control unit which is connected to the tensile force measuring means for the transmission of measurement data. The measurement data determined by the sensor device is transmitted to the control unit where it is processed further as necessary. In particular, said control unit is also connected to the previously described control unit or is integrated in the previously described control unit.

The control unit is preferably connected to the swivel drive. The measurement data determined by the tensile force measuring means is processed further in the control unit to generate control commands which are transmitted to the swivel drive, so that the swivel drive can adjust the straightening unit according to the measured wire tensile force.

More preferably, the control unit includes a computing unit and a memory unit, so that the transmitted measurement data are easily processed further to generate control commands.

In particular, the computing unit is designed to calculate at least the wire tensile force in the wire and to calculate an actual value based on the transmitted measurement data and at least one wire-specific parameter. The computing unit is further designed to retrieve a target value for said wire that is to be straightened from a table, which is typically stored in the memory unit, and then perform an actual value-target value comparison, so that subsequently the straightening unit is set or adjusted in accordance with a suitable wire tensile force. The computing unit of the control unit is designed to create at least one suitable control command from the actual value-target value comparison and to transmit this to the swivel drive of the straightening unit.

In particular, the computing unit is designed to calculate at least the wire tensile force and/or an actual value on the basis of the measurement data and at least one specific wire parameter. For this, the computing unit typically accesses a known mathematical relationship, a mathematical formula, which is typically stored in the memory unit. In this way, the straightening unit can be adjusted particularly effectively, so that a straightened wire of very high quality can be produced.

As was noted previously, the control unit is preferably connected to a database, wherein at least one target value for the wire tensile force is provided in the database.

The straightening device preferably includes a measuring unit for determining a wire diameter. The wire diameter thus determined can be considered when generating a control command for at least one drive in the straightening device. As was noted previously, the determination of the wire diameter in a straightening device enables the straightening of a wire to be improved. Advantageously, a straightening device with a measuring unit for determining a wire diameter and with a tensile force measuring means for determining a wire tensile force acting on the wire thus enables sufficient straightening to be performed on any possible wire type.

In particular, the measuring unit for determining a wire diameter is arranged on the straightening unit. Accordingly, this straightening unit is embodied as described previously.

More preferably, as described previously, this straightening device or the straightening device with the measuring unit for determining a wire diameter comprises a monitoring device for monitoring the straightening of the wire. This makes it possible to monitor the effect of the straightening unit in the process while the wire is being straightened, so that insufficient straightening of the wire can be detected early. Insufficiently straightened wires may be rejected from the processing process, for example, so that subsequently only sufficiently straightened wires are forwarded in the processing process. The monitoring device may be used to directly monitor a predefined space, such as a cylindrical lumen, or the space outside the cylindrical lumen.

In particular, the monitoring device is an optical or an acoustic or an airstream monitoring device. In this way, the straightened wire and/or the effect of the straightening unit can be monitored contactlessly. For example, one or more laser curtains or camera systems or dynamic pressure nozzles which monitor multiple angular planes around the predefined space may be used as monitoring devices.

The monitoring device preferably comprises at least one camera. This makes it possible to position the monitoring device separately from the straightening device and the straightening unit, so that no further components for monitoring the straightened wires are arranged directly on the straightening device.

In particular, the monitoring device is supplemented with at least one camera having at least two light guides. The at least one camera uses the two light guides to record two or more image sections, which can be combined optically. The effect of the straightening unit or the straightening device on the straightened wire can be determined with the aid of the image sections. The straightening of the wire on the straightening unit or straightening device may be improved further as necessary with the information derived therefrom.

The monitoring device preferably comprises at least two cameras, which are offset substantially at an angle of 90° relative to each other. The cameras may be used to record multiple angular planes, so that it is subsequently possible to monitor a predefined space, which in particular substantially has the form of a cylindrical lumen.

A further aspect of the invention relates to a wire processing machine comprising a previously described straightening device with a measuring unit for determining a wire diameter or a previously described straightening device with a tensile force measuring means for determining a tensile force acting on the wire. A wire processing machine is thus created in which the wires are sufficiently straightened to ensure that final processing of the wire in the wire processing machine proceeds without problems and scrap is avoided.

The wire processing machine preferably includes a further straightening unit. This further straightening unit may be designed as described herein. The further straightening unit enables further improvement in the straightening of the wire, as the wire to be straightened is also passed through the further straightening unit after it leaves the first straightening unit.

The further straightening unit is preferably offset through substantially 90° with respect to the respective straightening unit. Each of the straightening units has a longitudinal axis which corresponds substantially to the conveying direction of the wire. In this regard and in the following text, the term offset means that the straightening units are offset about their respective longitudinal axis. With this arrangement, the wire can be straightened in a first spatial direction by the one straightening unit and additionally straightened in another spatial direction by the further straightening unit.

In particular, the further straightening unit is arranged between the one straightening unit and the measuring unit for determining a wire diameter of the straightening device, or between the one straightening unit and the tensile force measuring means for determining a wire tensile force acting on the wire. In this way, the wire can be straightened both by the one straightening unit and by the further straightening unit, and can then be determined with the respective measuring unit, so that both the one straightening unit and the further straightening unit may be adjusted on the basis of the measurement data from the respective measuring units afterwards if necessary.

A further aspect of the invention relates to a wire processing machine comprising a straightening device as described previously, with a measuring unit for determining a wire diameter and a straightening device as described previously with a tensile force measuring means for determining wire tensile force acting on the wire. The straightening device with a measuring unit for determining a wire diameter and the straightening device with a tensile force measuring means for determining a wire tensile force acting on the wire are arranged so as to be offset by substantially 90° with respect to each other. In this way, the previously described advantages for sufficient straightening of the wires in the wire processing machine can be realised simply.

More preferably, the wire processing machines described herein are each equipped with a wire feed unit. These serve to transport the wire through the previously described straightening devices in controlled manner, so that the straightening of the wire can be carried out reproducibly.

In particular, the wire feed unit has at least one conveyor drive which is connected to the control unit of the previously described straightening devices, so that transporting the wire through the previously described straightening devices can be synchronised with the attached drives.

A further aspect of the invention relates to a method for adjusting a straightening unit in a straightening device for straightening a wire, in particular in a straightening device as described previously, wherein the method comprises the following steps:
providing the wire in a straightening unit and in a tensile force measuring means of the straightening device;
measuring measurement data with the tensile force measuring means;
determining an actual value for a wire tensile force on the basis of the measured measurement data;
providing, in particular calculating a target value for swivelling a first row of rollers of the straightening unit;
swivelling the first row of rollers of the straightening unit relative to a second row of rollers of the straightening unit on the basis of the target value.

With the aid of the tensile force measuring means and the tensile force determined therein, this may be determined for each wire to be straightened, according to which the straightening device may subsequently be adjusted to the respective wire to be straightened and overstretching of the wire during straightening is prevented.

The steps of:
measuring measurement data with the tensile force measuring means;
determining an actual value for a wire tensile force on the basis of the measured measurement data;
calculating a target value for swivelling a first row of rollers of the straightening unit;
swivelling the first row of rollers of the straightening unit relative to a second row of rollers of the straightening unit are preferably repeated on the basis of the target value.

Repetition or multiple repetitions of the steps listed above enables continuous improvement of the process steps when straightening the wire. In particular, the steps listed above are carried out continuously. In this way, the adjustment can be carried out continuously.

The measurement data from the tensile force measuring means are preferably transmitted to a control unit of the straightening device and processed further in the computing unit of the control unit. The control unit detects the wire that is to be straightened, wherein wire-specific parameters are input to the control unit by a user, for example. The computing unit determines or calculates an actual value for the wire tensile force from the measurement data. The computing unit further retrieves a target value for the wire tensile force for the wire that is to be straightened from a memory unit or database.

In particular, the computing unit of the control unit is designed to carry out an actual value-target value comparison for the wire tensile force and then to generate a corresponding swivelling control command for the swivel drive. This is then transmitted to the swivel drive.

More preferably, the method further comprises the steps of:
determining the wire diameter using a measuring unit;
calculating a target value for setting the first row of rollers relative to the second row of rollers on the basis of the determined wire diameter;
setting the first row of rollers relative to the second row of rollers in accordance with the target value.

In this way, the straightening unit can be set sufficiently to enable to enable a tensile force measurement which is carried out subsequently to be performed reproducibly. In particular, the steps described previously are carried out continuously, so that the straightening unit can be adjusted continuously. Accordingly, the wire diameter is determined continuously in the straightening unit, thereby guaranteeing consistent straightening quality of the wire.

Preferably, a wire-specific parameter is provided which is used in the calculation of the wire tensile force. This enables the adjustment of the straightening units to be tuned to the respective wire characteristics.

More preferably, the effect of the adjusted straightening device on the wire is checked with a monitoring device, the check data is stored in a memory unit. The check data is transmitted to the control unit, which processes the check data further.

Preferably after the first row of rollers has been set relative to the second row of rollers, the first row of rollers is opened relative to the second row of rollers to relieve stress on the wire. This prevents permanent plastic deformation of wire sections of the wire when the straightening unit is in the set state.

The first row of rollers is advantageously opened relative to the second row of rollers to relieve stress on the wire when the transport movement of the wire through the straightening unit is interrupted. Even short interruption times in the transport movement of the wire can result in plastic deformations in the wire. These plastic deformations make it almost impossible to continue processing the wires.

A further aspect of the invention relates to a method for adjusting a straightening unit in a straightening device for straightening a wire, wherein the method comprises the following steps:
providing the wire in a straightening unit;
setting a first row of rollers relative to a second row of rollers;
transporting the wire through the set straightening unit;
opening the first row of rollers relative to the second row of rollers to relieve stress on the wire in the straightening unit;
setting the first row of rollers relative to the second row of rollers again.

This prevents plastic deformation from occurring in the wire under tension when the transport movement of the wire through the straightening unit is interrupted. Even a short interruption in the transport movement of the wire can lead to plastic deformation (a wave form) in the wire section under tension in the area of the straightening unit rollers. This plastic deformation in this wire section renders this wire section incapable of being processed further afterwards.

A further aspect of the invention relates to a computer-implemented method for automatically determining and generating datasets and/or control commands for controlling at least one straightening device, particularly as described herein, with a measuring unit for determining a wire diameter and/or a straightening device, particularly as described herein, with a tensile force measuring means, which executes a method for straightening or adjusting a wire, particularly the methods as described herein.

A further aspect of the invention relates to a computer program product comprising control commands which cause the straightening devices described here to perform the described method steps, and a computer-readable medium on which the computer program is stored.

Further advantages, features and details of the invention will be evident from the following description, in which exemplary embodiments of the invention are described with reference to the drawing.

The list of reference numerals is an integral part of the disclosure, as are the technical content of the claims and figures. The descriptions of the figures are interrelated and unified. The same reference numerals denote identical components, reference numerals with different indices indicate functionally equivalent or similar components.

In the drawings:

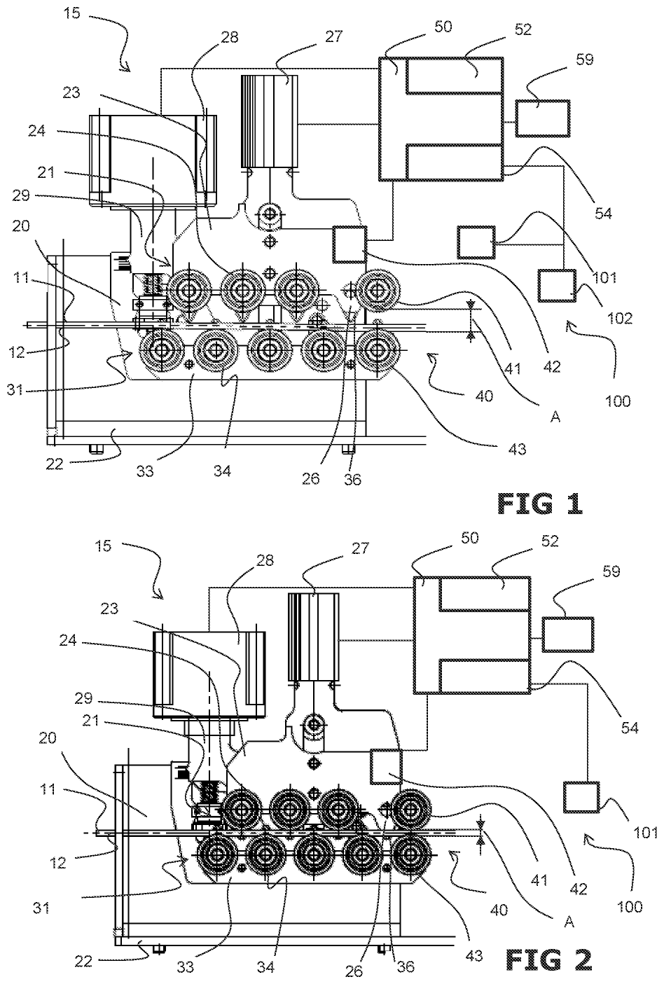

FIG. 1 shows a side view of a first embodiment of a straightening device according to the invention with open straightening unit and a measuring unit for determining a wire diameter,

FIG. 2 shows a side view of the straightening device of FIG. 1 with set straightening unit,

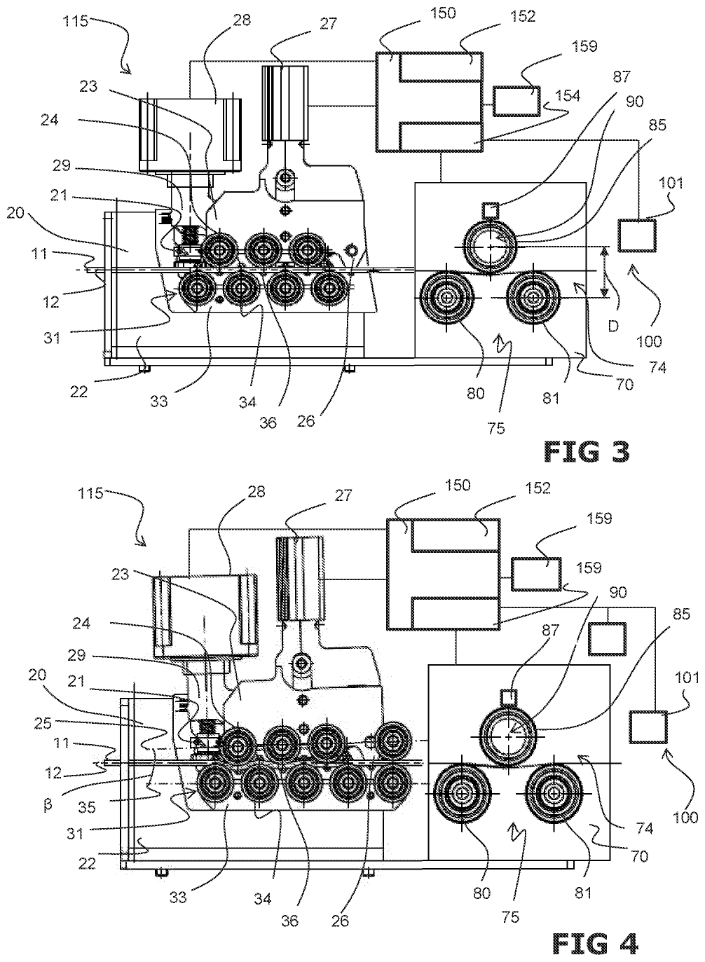

FIG. 3 shows a side view of a further embodiment of the straightening device according to the invention with a tensile force measuring means,

FIG. 4 shows a side view of the straightening device of FIG. 3,

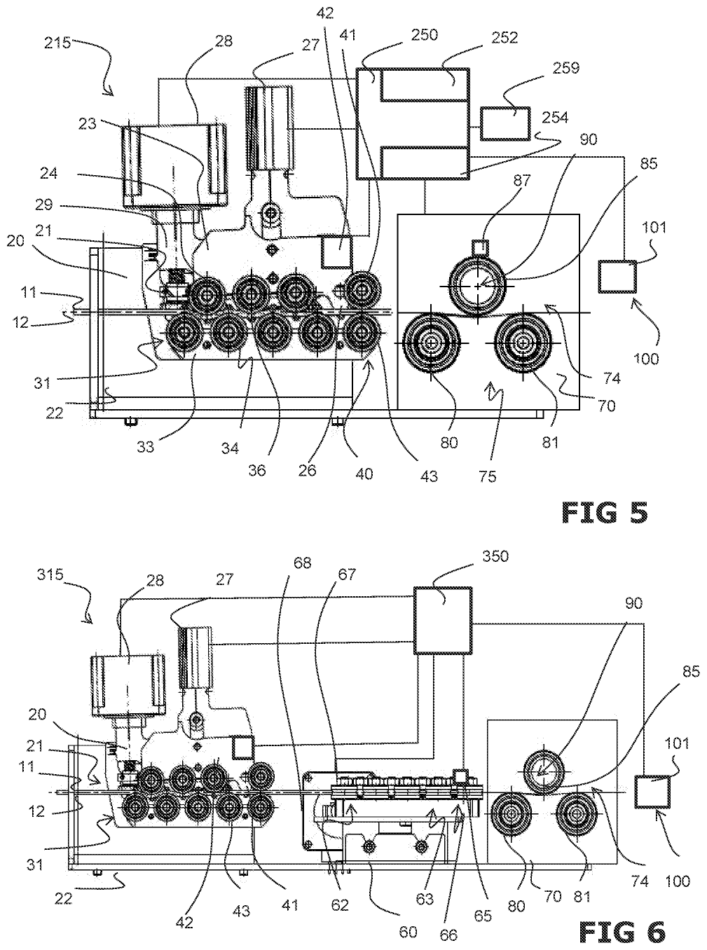

FIG. 5 shows a side view of a further embodiment of the straightening device of FIG. 1 and FIG. 2 according to the invention and with a tensile force measuring means according to FIG. 3 and FIG. 4,

FIG. 6 shows a side view of a further embodiment of the straightening device according to the invention of FIG. 5, and

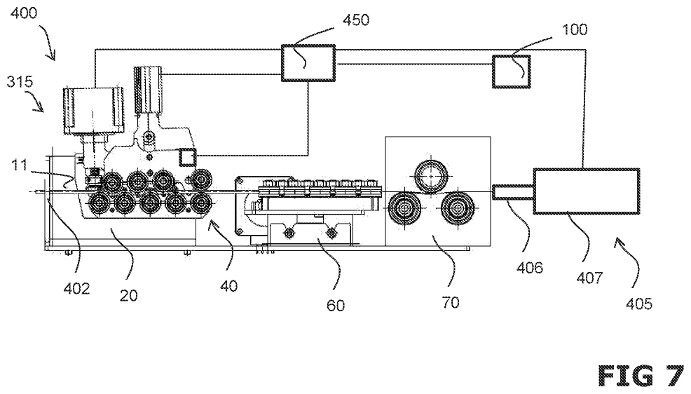

FIG. 7 shows a side view of a wire processing machine according to the invention with a straightening device of FIG. 6.

FIG. 1 shows a straightening device 15 for straightening an electrical or optical wire 11, with a straightening unit 20, with a control unit 50 and with a monitoring device 100. The straightening unit 20 comprises a basis 22, on which a first row of rollers 21 with multiple rotatably mounted rollers 24 is arranged, and a second row of rollers 31, with multiple rotatably mounted rollers 34 is arranged. In this figure and in the following figures, one roller is denoted 24 as representative of the multiple rollers with the same reference numeral 24, and one roller is denoted 34 as representative of the multiple rollers with the same reference numeral 34. The straightening unit 20 represented is in an open state, wherein the wire 11 is passed between the rollers 24 and the rollers 34 and rests on the rollers 34 along the wire axis 12. The rollers 24 are arranged with an offset in respect of the rollers 34 along the wire axis 12. The first row of rollers 21 arranged on a first carrier 23 and the second row of rollers is arranged on a second carrier 33. The first carrier 23 has protrusions 26 and the second carrier 33 has recesses 36, which at least partially engage with each other. The straightening unit 20 comprises a setting drive 27 and a swivel drive 28, each of which is connected to the control unit 50. The setting drive 27 comprises a pneumatically controlled drive and sets the first row of rollers 21 to the second row of rollers 31 so that the distance between the first row of rollers 21 and the second row of rollers 31 decreases until the rollers 24 of the first row of rollers 21 touch the wire 11 and hold the wire 11 or until the wire 11 is clamped between the rollers 24 and the rollers 34. The swivel drive 28 comprises an adjustment spindle 29, which swivels the first row of rollers 21 through an adjustable angle with respect to the second row of rollers 31, so that a portion of the wire to be straightened 11 is clamped and/or retained firmly in the straightening unit 20.

The straightening device 20 comprises a measuring unit 40 for determining the wire diameter of wire 11, which is arranged on the straightening unit 20. The measuring unit 40 comprises a rotatably mounted measuring roller 41, which is arranged movably on the first carrier 23, and a measuring roller drive 42. The measuring unit 40 further comprises a rotatably mounted contact pressure roller 43, which is arranged fixedly on the second carrier 33. The contact pressure roller 43 is arranged substantially directly opposite the measuring roller 41, wherein the wire 11 is supported on the contact pressure roller 43 and is held thereby in the measuring unit 40 in the open state. The measuring roller 41 is located at a distance (Distance A) from the contact pressure roller 43 and is connected to the measuring roller drive 42, which sets the measuring roller 41 to the wire 11 and moves it towards the contact pressure roller 43. The measuring roller drive 42 is designed to move the measuring roller 41 away from the wire 11 and to move the measuring roller 41 away from the contact pressure roller 43. The measuring unit 40 and the measuring roller drive 42 are connected to the control unit 50. The measuring roller drive 42 comprises a pneumatic drive, with which the measuring roller 41 is pressed against wire 11 with a contact pressure, so that the wire 11 is pressed against the contact pressure roller 34.

FIG. 2 shows the previously described straightening device 15, wherein the first row of rollers 21 has already been set to the second row of rollers, so that the straightening unit 20 is already in a closed state. In this condition, the rollers 24 of the first row of rollers 21 lie on the wire 11. A travel sensor is arranged on the measuring roller drive 42 and calculates the distance travelled by the measuring roller 41 from the open state as shown in FIG. 1 to the closed state as shown here. This distance travelled by the measuring roller 41 is transmitted to the control unit 50 as measurement data. The control unit 50 comprises a computing unit 52 and a memory unit 54, which are integrated in the control unit 50 and connected to each other. The control unit 50 is connected to a database 59. The control unit 50 transmits the received measurement data to the computing unit 52. The computing unit 52 uses the transmitted measurement data to determine the wire diameter of the wire 11 and the distance A between the measuring roller 41 and the contact pressure roller 43, which corresponds to the wire diameter of wire 11, and from the determined wire diameter calculates a target value for setting the first row of rollers 21 to the second row of rollers 31. In this process, the computing unit 52 takes account of wire-specific parameters of wire 11, which the computing unit retrieves either from the memory unit 52 or from the database 59. The computing unit 52 generates a control command for setting the first row of rollers 21 to the second row of rollers 31 on the basis of the calculated target value. The calculated target value and/or the generated control command is then stored in the memory unit 54 and/or in the database 59. Alternatively, the computing unit retrieves a control command for the setting drive 27 from the memory unit 54 or from the database 59, which corresponds to the calculated wire diameter of the wire 11. The control unit 50 transmits the control command to the setting drive 27. The setting drive 27 sets the first row of rollers 21 to the second row of rollers 31 in accordance with the calculated target value. Then, the first row of rollers 21 is swivelled towards the second row of rollers 34 by means of the swivel drive 28, so that an angle between the roller axis 25 of the first row of rollers 21 and the roller axis 35 of the second row of rollers 31 is set. Consequently, wire 11 is clamped between the first row of rollers 21 and the second row of rollers 31, following which the straightening of the wire 11 is carried out by transporting the wire 11 along the wire axis 12, thereby producing a sufficiently straightened wire. Because of the angle, the wire 11 is straightened degressively, i.e. it is initially subjected to relatively intense deformation, and is deformed with decreasing amplitude by the subsequent rollers. Consequently, the straightened wire loses its “shape memory” for the subsequent processing (not shown). A sufficiently straightened wire 11 is identifiable as such in that after straightening it can be inserted in a predefined space, a cylindrical lumen, for example, but does not protrude beyond the boundaries of this space. It should also be noted that if the transport movement of the wire 11 through the straightening unit 20 is interrupted, the shape memory of wire 11 causes it to recreate the plastic deformation it underwent between the rollers 24 and 34. For this reason, if the transport movement of the wire 11 is interrupted, the tension is removed from the straightening units 20 by opening the first row of rollers 21 relative to the second row of rollers 31 to such an extent that wire 11 does not return to any plastic deformation. The straightening units 20 are reset to the previously determined target value as soon as the transport movement of the wire 11 resumes. In this way, deformations of the wire when the transport stops are reliably prevented.

The straightening device 15 comprises a monitoring device 100 for monitoring the straightening of wire 11. The monitoring device 100 comprises two cameras 101 and 102, which are connected to the control unit 50 and are arranged around the straightened wire 11 (see FIG. 1). The two cameras 101 and 102 are offset by a (spatial) angle of 90° with respect to one other. The cameras 101 and 102 produce check data in that the cameras 101 and 102 record multiple images. The two cameras 101 and 102 are arranged in the area around the straightened wire 11 so that the angular plane of the respective camera capture a predefined space, for example a cylindrical lumen and record images of the straightened wire 11 in this predefined space, and then transmit them as check data to the control unit 50. The images are processed further in the control unit 50, and are optionally taken into account in the calculation of the target value for setting the first row of rollers 21 to the second row of rollers 31.

The steps described with the aid of FIG. 1 and FIG. 2 for setting the first row of rollers 21 relative to the second row of rollers 31 of the straightening unit 20 are performed continuously and optionally repeated multiple times until a sufficiently straightened wire can be produced. The previously described measuring unit 40 may be positioned at a distance from the straightening unit 20 and may thus be an independent measuring unit (not shown) arranged in the straightening device 15.

FIG. 3 shows a further embodiment of the straightening device 115 for straightening an electrical or optical wire 11 with a straightening unit 120, with a control unit 150 and with a monitoring device 100. In contrast to the previously described embodiment of the straightening device, the straightening device 115 described hereinafter has a tensile force measuring means 70 for determining a wire tensile force acting on the wire 11.

In the following description relating to FIG. 3 and FIG. 4, reference is made to FIGS. 1 and 2 in the case of identical components.

The tensile force measuring means 70 includes a group of rollers 74, which is connected to the control unit 150. The group of rollers 74 comprises a support 75 and a contact pressure roller 85, wherein the support 75 is constructed in two parts and comprises a first support roller 80 and a second support roller 81, each of which is mounted rotatably on the support 75. The two support rollers 80 and 81 are arranged at a distance from one another. Wire 11 is arranged in the group of rollers 74, wherein the wire 11 is positioned on the two support rollers 80 and 81. The contact pressure roller 85 is arranged on the wire 11. In this arrangement, the contact pressure roller 85 bears on the wire 11 in such manner that at least a portion of the wire 11 is pressed between the first support roller 80 and the second support roller 81, so that the guided wire 11 is deflected substantially in a V-shape. The contact pressure roller 85 is advantageously movable relative to the two support rollers 80 and 81 with the aid of a contact pressure roller drive 87, so that the wire 11 is deflected by the contact pressure roller 85 as it is transported through the group of rollers 74. A sensor device 90 is arranged on the contact pressure roller 85, and measures the radial force acting on the contact pressure roller 85 when the contact pressure roller 85 is deflected. For this purpose, a force transducer is arranged between the contact pressure roller 85 and the contact pressure roller drive 86 in order to measure the radial force acting on the contact pressure roller 85. The force transducer is equipped with multiple strain gauges, whose voltages can be tuned with the aid of a Wheatstone bridge. The contact pressure roller 85 is arranged on a carriage and is movable along a carriage guide (not shown). The distance D between the contact pressure roller 85 and the support rollers 80 and 81 is adjustable using the contact pressure roller drive 86. The contact pressure roller 85 is mounted rotatably on the carriage. The sensor device 90 is connected to the control unit 150 and transmits the radial force acting at the contact pressure roller 85, which is measured by the strain gauge, and the previously described distance D to the control unit 150 as measurement data. In addition, the wire diameter measured as described in FIG. 1 and FIG. 2 and the distance between the support rollers 80 and 81 are stored in the control unit 150. The computing unit 152 contained in the control unit 150 calculates an actual value for the wire tensile force acting on the wire 11 from the measurement data and the stored data. The computing unit 152 is connected to the memory unit 154 and the database 159, so that the computing unit 152 can retrieve wire-specific parameters associated with the wire 11 and may optionally take them into account when calculating the wire tensile force acting on the wire 11. The computing unit 152 calculates a target value for the wire tensile force of the wire 11 to be straightened or retrieves a target value for the wire tensile force of wire 11 from the memory unit 154 or the database 159. Then, the computing unit 152 performs an actual value-target value comparison for the wire tensile force and generates a control command for the swivel drive 28 based on the actual value-target value comparison.

If the actual value of the wire tensile force matches the target value, angle β does not have to be changed. If the actual value of the wire tensile force is less than the permitted target value, angle β is changed by the swivel drive 28 in such manner that the wire 11 is smoothed more intensely, so that a greater wire tensile force results therefrom as the wire is advanced. If the actual value of the wire tensile force is greater than the permitted target value, angle β is opened correspondingly be the swivel drive 28, so that a lesser wire tensile force results therefrom as the wire is advanced. After the described correction of angle β the wire tensile force must be measured again, followed by another actual value-target value comparison, possibly several times. The objective is to comply with the permitted target value as closely as possible.

The control command described previously is transmitted to the swivel drive 28 by the control unit 150 causing the swivel drive to swivel the first row of rollers 21 relative to the second row of rollers 31 by means of the adjustment spindle 29, so that angle β between the roller axis 25 of the first row of rollers 21 and the roller axis 35 of the second row of rollers 31 derived from the result of the calculation by the control unit 150 is adjusted. The calculated target value of angle β may be stored in the memory unit 154 or in the database 159.

FIG. 4 shows the straightening device 115 according to FIG. 3 with a first row of rollers 21 swivelled towards the second row of rollers 31 in the straightening unit 20, wherein the roller axis 25 of the first row of rollers 21 is swivelled through an angle β towards the roller axis 35 of the second row of rollers 31. The swivelling action causes a section of the wire 11 in the straightening unit 20 to be bent, wherein the rollers 24 of the first row of rollers 21 are arranged so as to be offset with respect to the rollers 34 of the second row of rollers 31. This causes the wire to be held firmly between the rollers 24 and the rollers 34. If the wire 11 in the straightening unit 20 is pulled, the radial force acting on the contact pressure roller 85 changes, which alters the deflection of the contact pressure roller 85. The resulting further measurement data measured by the sensor device 90 is transmitted to the control unit 150. A new target value generated in the computing unit 152 for the wire tensile force acting on the wire 11 using the further measurement data as previously described, and the steps described previously are repeated until the swivelling of the first row of rollers 21 relative to the second row of rollers 31 is optimised incrementally in such manner that the tensile force corresponds to a value that correlates to a sufficiently straightened wire 11 and which is permissible for the wire, that is to say it does not overstretch or destroy the wire. The defined steps are repeated and carried out continuously. If required, the new target value is assigned to the wire or to the wire tensile force for the wire 11 and is saved in a table in the memory unit 154 or the database 159.

The straightening device 115 described comprises a monitoring device 100 for monitoring the straightening of wire 11, as was described previously in FIG. 1 and FIG. 2.

FIG. 5 shows a straightening device 215 according to FIG. 1 and FIG. 2. This straightening device 215 is additionally equipped with a tensile force measuring means 70, as was described with reference to FIG. 3 and FIG. 4.

In the following description identical components will be denoted with the reference numerals used in FIGS. 1 to 4.

The straightening device includes a straightening unit 20. The measuring unit 40 is arranged on this straightening unit (see also in FIG. 1 and FIG. 2). This is followed in the transport direction of the wire 11 by the tensile force measuring means 70, as was described with reference to the straightening device 115 according to FIG. 3 and FIG. 4. The wire 11 is straightened in this straightening device 215, as was described in detail in FIG. 1 and FIG. 2 and in FIG. 3 and FIG. 4. The straightening device 215 has a control unit 250, which is designed to generate the control commands as generated by control unit 50 according to FIG. 1 and FIG. 2 as well as the control commands as generated by the control unit 250 according to FIG. 3 and FIG. 4, and to transmit them to the previously described drives. For this purpose, the control unit 250 has a computing unit 252 which is able to carry out the calculations of the computing unit according to FIG. 1 and FIG. 2 as well as the calculations of the computing unit according to FIG. 3 and FIG. 4 and to combine them if necessary. After the wire 11 is provided in the straightening unit 20, the wire diameter of the wire 11 is determined with the measuring roller 41 and the contact pressure roller 43 of the measuring unit 40. Then, the measurement data measured by the measuring unit 40 are transmitted to the computing unit 252 and a target value for setting the first row of rollers 21 to the second row of rollers 31 is calculated based on the determined wire diameter. The control command which is generated on the basis of the target value is transmitted to the setting drive 27, and the first row of rollers 21 is set as described previously. Then, the wire 11 is provided in the tensile force measuring means 70 by feeding the wire 11 through the group of rollers 74. Then, the radial forces acting on the contact pressure roller 85 is measured with the sensor device 90 and the measurement data is transmitted to the control unit 250, which calculates an actual value with the computing unit 252 and/or carries out an actual value-target value-comparison. Subsequently, the computing unit 252 determines a wire tensile force on wire 11, as was described earlier in FIG. 3 and FIG. 4. Then, the first row of rollers 21 of the straightening unit 20 is set to the second row of rollers 31 of the straightening unit 20 using the calculated actual value or the actual value-target value comparison. The steps lust described are repeated and performed continuously. The control unit 250 includes a memory unit 254 and a database 259. The straightening device 215 described comprises a monitoring device 100 for monitoring the straightening of the wire 11, as was described earlier in FIG. 1 and FIG. 2.

FIG. 6 shows a further embodiment of the straightening device 315 according to the invention with a straightening device as represented in FIG. 5 and with a further straightening unit 60. In the following description identical components will be denoted with the reference numerals used in FIGS. 1 to 5. The further straightening unit 60 is offset by 90° about its longitudinal axis with respect to the first straightening unit 20 and is arranged between the first straightening unit 20 and the group of rollers 74. The further straightening unit 60 includes substantially the same components as the straightening unit 20. Wire 11 is provided between the first row of rollers 62 and the second row of rollers 63 of the further straightening unit 60 and held firmly in place by the rollers thereof. The measuring roller drive 65 of the measuring unit 66 for determining the wire diameter of wire 11 is connected to the control unit 350 for the purpose of exchanging measurement data. The setting drive 67 and the swivel drive 68 of the further straightening unit 60 are connected to the control unit 250 in order to receive control commands. The described straightening device 315 as represented in FIG. 6 comprises a monitoring device 100 for monitoring the straightening of the wire 11 as was described earlier in the notes on FIG. 1 and FIG. 2.

FIG. 7 shows a side view of a wire processing machine 400 according to the invention, with a straightening device 315 according to FIG. 6. In the following description identical components will be denoted with the reference numerals used in FIGS. 1 to 6. The wire processing machine 400 has a wire feed 402 and a wire feed unit 405, wherein the wire feed unit 405 advances the wire that is to be straightened 11 through the one straightening unit 20, through the further straightening unit 60 and through the tensile force measuring means 70. The wire feed unit 405 includes a guide tube 406 for guiding the wire 11 and includes a conveyor drive 407 for advancing the wire 11 through the wire processing machine 400. The conveyor drive 207 is connected to the control unit 450. As previously described herein, the control unit 450 generates control commands based on the measurement data from measuring unit 40 for determining the wire diameter and/or based on the measurement data from the tensile force measuring means 70 for determining the wire tensile force. With these control commands, the conveying speed of the wire 11 through the straightening device 315 is controlled so that a sufficiently straightened wire is produced.

These steps as described in FIG. 1 to FIG. 7 may optionally be applied in a computer-implemented method for automatically determining and generating datasets and/or control commands for controlling the straightening device described herein and/or for controlling the wire processing machine described herein, which executes a method described herein for straightening or adjusting the wire 11. The datasets and/or control commands are stored in a computer program product and stored on a computer-readable medium.

### LIST OF REFERENCE NUMERALS

11 Wire
12 Wire axis
15 Straightening device
20 Straightening unit
21 First row of rollers
22 Basis
23 First carrier
24 Rollers from 21
25 Axis of rollers from 21
26 Protrusion
27 Setting drive
28 Swivel drive
29 Adjustment spindle
31 Second row of rollers
33 Second carrier
34 Rollers from 31
35 Roller axis from 31
36 Recess
40 Measuring unit
41 Measuring roller
42 Measuring roller drive
43 Pinch roller
50 Control unit
52 Computing unit
54 Memory unit
59 Database
60 Additional straightening unit
62 First row of rollers from 60
63 Second row of rollers from 60
65 Measuring roller drive
66 Measuring unit
67 Setting drive
68 Swivel drive
70 Tensile force measuring means
74 Group of rollers
75 Support
80 First support rollers
81 Second support rollers
85 Contact pressure roller
87 Contact pressure roller drive
90 Sensor device
100 Monitoring device
101 Camera
102 Second camera
115 Straightening device
150 Control unit
152 Computing unit
154 Memory unit
159 Database
215 Straightening device
250 Control unit
252 Computing unit
254 Memory unit
259 Database
315 Straightening device
350 Control unit
400 Wire processing machine
402 Wire feed
405 Wire feed unit
406 Guide tube
407 Conveyor drive
450 Control unit
A Distance between 41 and 43
D Distance between 80 or 81 and 85
β Angle between 25 and 35

1-31. (canceled)

32. A straightening device (15; 115; 215; 315) for straightening a wire (11) comprising:
a straightening unit (20) with a first row of rollers (21), and
a second row of rollers (31) which are movable relative to the first row of rollers (21),
wherein the straightening device (15; 115; 215; 315) includes a measuring unit (40) for determining a wire diameter, and
the measuring unit (40) is arranged on the straightening unit (20).

33. The straightening device (15; 115; 215; 315) according to claim 32, wherein the measuring unit (40) for determining the wire diameter is embodied as an ultrasonic sensor or as a laser sensor.

34. The straightening device (15; 115; 215; 315) according to claim 32, wherein the measuring unit (40) includes at least one measuring roller (41) and one pinch roller (43) arranged opposite the measuring roller (41), the measuring and pinch rollers (41, 43) are arranged in such a manner that the wire can be transported between the measuring roller (41) and the pinch roller (43), and a distance (A) between the measuring roller (41) and the pinch roller (43) is adjustable with a measuring roller drive (42) for moving the measuring roller (41).

35. The straightening device (15; 115; 215; 315) according to claim 32, wherein the measuring unit (40) for determining the wire diameter includes at least one sensor from the group consisting of: a travel sensor, a position sensor, a distance sensor, or a goniometer.

36. The straightening device (15; 115; 215; 315) according to claim 34, wherein the pinch roller (43) is arranged on the second row of rollers (31).

37. The straightening device (15; 115; 215; 315) according to claim 36, wherein, the second row of rollers (31) includes multiple rollers (34), and the pinch roller (43) is embodied as one of the multiple rollers (34).

38. The straightening device (15; 115; 215; 315) according to claim 32, wherein the straightening device (15; 115; 215; 315) has a control unit (50; 150; 250; 350; 450), and the control unit (50; 150; 250; 350; 450) includes a computing unit (52; 152; 252) and a memory unit (54; 154; 254).

39. The straightening device (15; 115; 215; 315) according to claim 38, wherein, the control unit (50; 150; 250; 350; 450) is connected to a database (59).

40. The straightening device (15; 115; 215; 315) according to claim 37, wherein the measuring unit (40) is connected to the control unit (50; 150; 250; 350; 450) for transmitting measurement data and the control unit (50; 150; 250; 350; 450) is connected to the measuring roller drive (42).

41. The straightening device (15; 115; 215; 315) according to claim 32, wherein the straightening unit (20) includes a setting drive (22), with which the first row of rollers (21) can be set relative to the second row of rollers (31), and the straightening unit (20) has a swivel drive (28) for adjusting an angle between a roller axis (25) of the first row of rollers (21) and a roller axis (35) of the second row of rollers (31).

42. The straightening device (15; 115; 215; 315) according to claim 32, wherein the straightening device (15; 115; 215; 315) includes a tensile force measuring means (70) for determining a wire tensile force acting on the wire (11).

43. The straightening device (15; 115; 215; 315) according to claim 32, comprising a monitoring device (100) for monitoring the straightening of the wire (11), and the monitoring device (100) is one of an optical, an acoustic or an airstream monitoring device (100).

44. The straightening device (15; 115; 215; 315) according to claim 43, wherein the monitoring device (100) comprises at least one camera (101).

45. A method for operating the straightening unit in the straightening device (15; 115; 215; 315) according to claim 32, wherein the method comprises the following step:
providing a wire (11) between the first row of rollers (21) and the second row of rollers (31) in the straightening unit (20);
determining the wire diameter of the wire (11) using a measuring unit (40);
calculating a target value for setting the first row of rollers (21) relative to the second row of rollers (31) based on the determined wire diameter;
setting the first row of rollers (21) relative to the second row of rollers (31) in accordance with the target value.

46. The method according to claim 45, wherein the steps of
determining the wire diameter of the wire using the measuring unit (40);
calculating the target value for setting the first row of rollers (21) relative to the second row of rollers (31) based on the determined wire diameter; and
setting the first row of rollers (21) relative to the second row of rollers (31) in accordance with the target value.

47. The method according to claim 45, wherein a wire-specific parameter is taken into account for calculating the target value in the straightening unit (20).

48. The method according to claim 45, wherein after setting of the first row of rollers (21) relative to the second row of rollers (31), the first row of rollers (21) is opened relative to the second row of rollers (31) to relieve stress on the wire (11).

49. The wire processing machine (400) comprising the straightening device (15; 115; 215; 315) according to claim 32 and a second straightening device (15; 115; 215; 315) comprising: a straightening unit (20) with a first row of rollers (21), and a second row of rollers (31) which are movable relative to the first row of rollers (21), wherein the straightening device (15; 115; 215; 315) includes a tensile force measuring means (70) for determining a wire tensile force acting on the wire (11),
wherein the straightening device (15; 115; 215; 315) according to claim 32 and the second straightening device are arranged with an offset of substantially 90° with respect to one another.

50. The wire processing machine (400) according to claim 49, wherein the wire processing machine (400) includes a wire feed unit (405).
